(19) United States
(12) Patent Application Publication
(10) Pub. No.: US 2021/0319033 A1
(43) Pub. Date: Oct. 14, 2021

(54) LEARNING TO RANK WITH ALPHA DIVERGENCE AND ENTROPY REGULARIZATION

(71) Applicant: Microsoft Technology Licensing, LLC, Redmond, WA (US)

(72) Inventors: Xiaohai Zhang, San Francisco, CA (US); Liang Zhang, Fremont, CA (US)

(21) Appl. No.: 16/844,909

(22) Filed: Apr. 9, 2020

(51) Int. Cl. G06F 16/2457; G06F 16/953; G06N 20/00; G06N 5/04

(52) U.S. Cl. CPC G06F 16/24578; G06N 5/04; G06N 20/00; G06F 16/953

(57) ABSTRACT

In an example embodiment, α-divergence is used to replace cross-entropy or KL-divergence as the loss function for learning-to-rank tasks in an online network. Additionally, in an example embodiment, entropy regularization is used to encourage score diversity for documents of the same relevance level. The result of both these approaches it to reduce or eliminate technical problems encountered using prior art techniques.

### TECHNICAL FIELD

The present disclosure generally relates to technical problems encountered in machine learned models, specifically machine learned models to rank search results using a “learning to rank” algorithm. More specifically, the present disclosure relates to the alpha divergence and entropy regularization in learning to rank algorithms.

### BACKGROUND

The rise of the Internet has occasioned two disparate yet related phenomena: the increase in the presence of social networking services, with their corresponding member profiles visible to large numbers of people, and the increase in the use of these social networking services to provide content. An example of such content is a social media post, where a member can post information, such as text, pictures, videos, articles, etc., for other members to view.

As the number of users and pieces of content on these social networking services grows, it can be difficult for users to find relevant information they are searching for, whether it is content or other users. Machine learning algorithms may be used to train machine learned ranking models to rank search results based on an estimated relevance of the results to the user, thereby making more relevant results easier to identify from large groups of search results.

One technique that has been used to train models to rank search results is known as a “learning-to-rank” algorithm. Learning-to-rank is a class of techniques that apply supervised machine learning to solve ranking problems. Traditional ranking algorithms rely on manual feature engineering to compute ranking scores for candidate items. Learning-to-rank algorithms, however, rely on training data of large number of relevant features to train a model that computes scores automatically without feature engineering. Listwise Learning-to-rank algorithms solve a ranking problem on a list of items, and the goal is to derive an optimal ordering of the items. As such, listwise learning-to-rank does not care as much about the exact score that each item received, but cares more about the relative ordering among all the items.

The three categories of learning-to-rank algorithms are pointwise, pairwise, and listwise. Of those, listwise tends to be the most popular as it usually performs better (i.e., more accurate rankings) than the other approaches.

In a listwise approach, the input is a complete list of document objects for a query represented as query-document feature vectors, and the output is a permutation of the objects. In practice, the output permutation is usually generated by sorting object scores generated by a ranking function that maps each object input vector to a corresponding score value. During training time, the dissimilarity measure (i.e., loss function) between object scores from the ranking function, and the corresponding list of ground truth relevance levels in training data, is computed as a loss. The average loss over the training data set is then minimized to obtain the optimal parameter values for the ranking function. At testing time, information retrieval (IR) metrics such as normalized discounted cumulative gain (nDCG), expected reciprocal rank (ERR), mean average prediction (MAP), and mean reciprocal rank (MRR) are commonly used to evaluate algorithm performances. The selection of a good ranking function, as well as a good loss function, plays a central role in the success of a listwise approach.

For loss functions, several methods have been developed, and they can be grouped into two categories. Methods in the first category use surrogate objective functions that are upper bounds or smoothed versions of corresponding informational retrieval (IR) measures. Examples in the first category include ApproxNDCG, SoftRank, and smooth hinge functions for smoothing discounted cumulative gain (SHF-SDCG). Methods in the second category use probabilistic approaches where lists of object scores (and ground truth relevance values) are first mapped to probability distributions, and then likelihood or statistical distance measures are used to construct loss functions. ListNet, ListMLE, and WassRank are examples in the second category. There are still open issues regarding the first category of methods. Some of the adopted surrogate functions are not convex and hard to optimize, and without sufficient theoretical understanding it is not clear whether optimizing surrogate functions can indeed optimize corresponding IR metrics. For the second category of algorithms, although the loss functions and IR metrics are not directly related, experiments show that good results in terms of IR metrics can be achieved.

Cross-entropy and Kullback-Leibler divergence are the most popular dissimilarity measures for probability distributions. These measures result in technical issues, however, when used in learning-to-rank algorithms in large online systems. They are not convex with respect to both input distributions and do not have a unique minimum when the two distributions are the same. The result is that modeling flexibility is achieved.

Additionally, in large online networks, such as networks with user profiles, ground truth relevance levels in labeled data often have much less granularity than score outputs from ranking functions. For example, training and testing data sets may have three manually labeled relevance levels 0, 1 and 2, while score outputs from models are usually floats or integers with large range. The assigned scores may wind up lacking variations for items at the same ground truth relevance level.

With sufficiently large modeling capacity in ranking function, minimization of loss functions can force the assigned scores to have small variation for documents at the same ground truth relevance level. The deterministic minimization behavior does not reflect the inherent uncertainty about training data and can lead to overfitting.

The result of both these technical issues is that the rankings may be inaccurate.

What is needed is a solution that solves these technical issues.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating an application server module of FIG. 2 in more detail, in accordance with an example embodiment.

FIG. 4 is a block diagram illustrating the search result generator of FIG. 3 in more detail, in accordance with an example embodiment.

FIG. 5 is a screen capture illustrating a graphical user interface for displaying results of the ranking performed in FIG. 4.

FIG. 6 is a flow diagram illustrating a method of performing machine learning in accordance with an example embodiment.

FIG. 7 is a block diagram illustrating a software architecture, in accordance with an example embodiment.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

In an example embodiment, α-divergence is used to replace cross-entropy or KL-divergence as the loss function for learning-to-rank tasks in an online network. Additionally, in an example embodiment, entropy regularization is used to encourage score diversity for documents of the same relevance level. The result of both these approaches it to reduce or eliminate the technical problems described above.

Specifically, a search may be conducted using a search query. This search query may be explicitly provided by a user (such as by entering keywords or selecting filters), implied on behalf of the user (such as by assuming, for example, that a user would have intended to enter keywords or select filters that are similar to his or her own profile), or any combination of explicitly provided and implied. The search query may then be utilized by a search engine to retrieve a plurality of matching search results.

At that point, a ranking process may be undertaken to rank the search results so that they may be presented (if applicable) in the order in which they would be most relevant to the user (such as by ranking all the search results and then presenting the top 10, in order, on a first results screen). In an embodiment, this ranking process is performed by a machine learned model, which is trained by a machine learning algorithm to assign a score to each search result based on some combination of features. These may be features of the results, features of the user performing the search, features of the search query itself, etc.

The machine learning algorithm may train the machine learned model by performing a plurality of iterations using labeled sample data until a specified loss function is minimized. The loss function acts to produce a larger number if predictions by the machine learned model deviate too much from the labeled sample data.

In an example embodiment, α-divergence is used as this loss function. α-divergence provides more choices for measuring the similarity between the modeled predictions and the labeled sample data. Specifically, α-divergence is a parametric family of divergence functions. It can be shown that the constructed loss function can have the property that all its stationary points are its global minimum.

Additionally, in some example embodiments, entropy regularization is used to encourage score diversity for documents at the same relevancy level. The entropy regularization ensures that the problem has a unique solution, greater computational stability, and an efficient Sinkhorn algorithm, which will be described in more detail below.

### Description

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In one example embodiment, search results from various searches in an online network may be sorted using the techniques described in this document, which results in more accurate results. Examples of types of searches in the online network that could benefit from this solution include searches for business leads, searches for users, and organization accounts. For simplicity, throughout this document an example use case involving a recruiter searching for users of an online network to potentially fill a job opening is described, but one of ordinary skill in the art will recognize that the scope of the claims shall not be limited to this example use case unless explicitly stated.

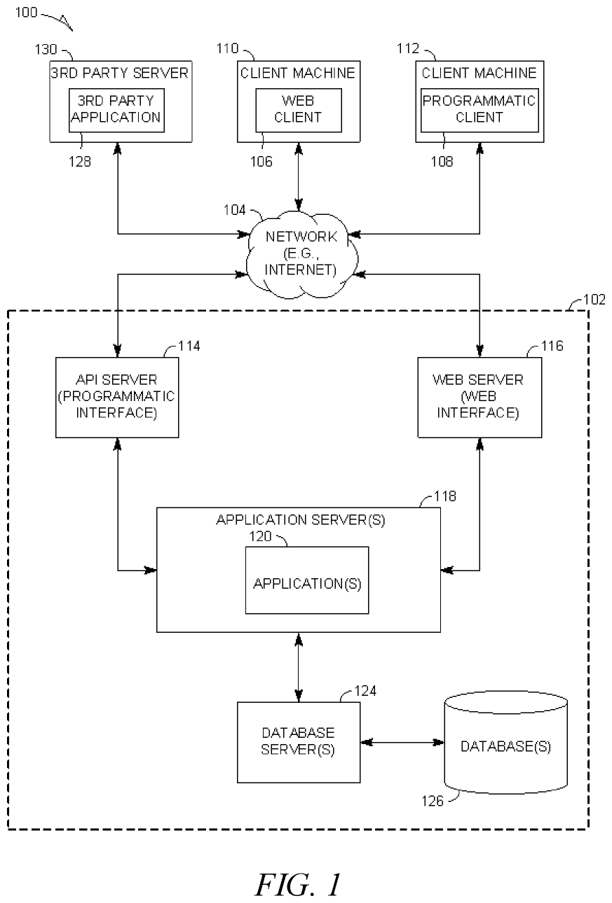

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third-party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

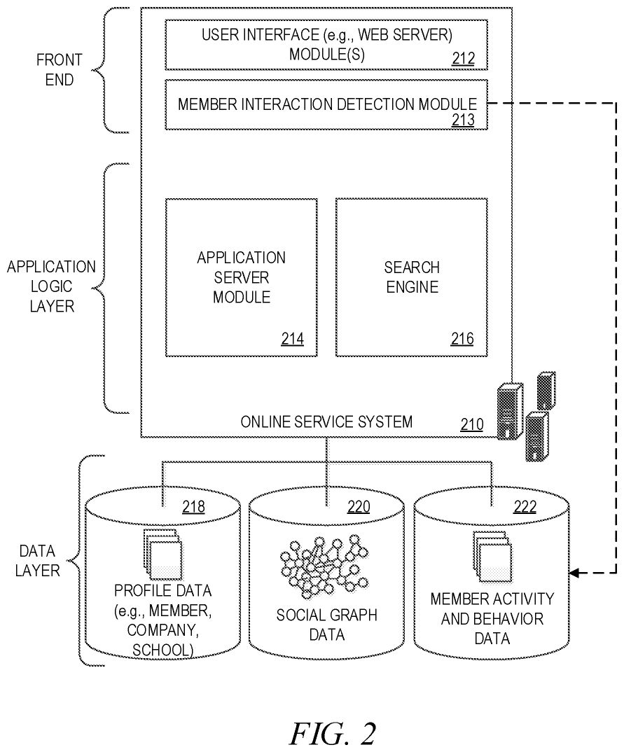

In some embodiments, the networked system 102 may comprise functional components of an online service. FIG. 2 is a block diagram showing the functional components of an online service, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module (e.g., a web server 116) 212, which receives requests from various client computing devices and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the online service.

As shown in FIG. 2, the data layer may include several databases, such as a profile database 218 for storing profile data, including both member profile data and profile data for various organizations (e.g., companies, schools, etc.). Consistent with some embodiments, when a person initially registers to become a member of the online service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Once registered, a member may invite other members, or be invited by other members, to connect via the online service. A “connection” may constitute a bilateral agreement by the members, such that both members acknowledge the establishment of the connection. Similarly, in some embodiments, a member may elect to “follow” another member. In contrast to establishing a connection, the concept of “following” another member typically is a unilateral operation and, at least in some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in a social graph database 220.

As members interact with the various applications 120, services, and content made available via the online service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the online service system 210 provides an API module via which applications 120 and services can access various data and services provided or maintained by the online service. For example, using an API, an application may be able to request and/or receive one or more navigation recommendations. Such applications 120 may be browser-based applications 120 or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the online service, nothing other than data privacy concerns prevents the API from being provided to the public or to certain third parties under special arrangements, thereby making the navigation recommendations available to third party applications 128 and services.

Although the search engine 216 is referred to herein as being used in the context of an online service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the online service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

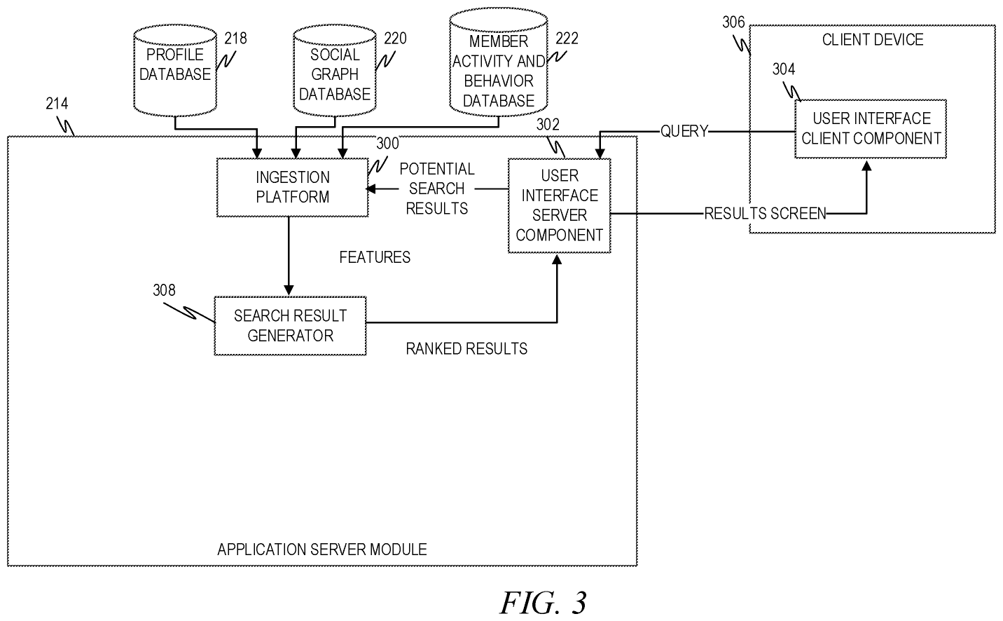

FIG. 3 is a block diagram illustrating an application server module 214 of FIG. 2 in more detail. While in many embodiments the application server module 214 will contain many subcomponents used to perform various different actions within the social networking system, in FIG. 3 only those components that are relevant to the present disclosure are depicted. Here, an ingestion platform 300 obtains information from the profile database 218, the social graph database 220, and the member activity and behavior database 222 relevant to a query submitted by a searcher via a user interface server component 302. The user interface server component 302 communicates with a user interface client component 304 located on a client device 306 to obtain this identification information. The details of the user interface client component 304 will be described in more detail below, but generally a user, known hereafter as a searcher, of the user interface client component 304 may begin a search or otherwise cause generation of a search that provides search results of members with whom the searcher may wish to communicate. Information about each of these members is identified in the search results. The user interface server component 302 may generate potential search results based on the query and send identifications of these potential search results to the ingestion platform 300, which can use the identifications to retrieve the appropriate information corresponding to those potential search results from the profile database 218, the social graph database 220, and the member activity and behavior database 222. As will be discussed in more detail below, in some example embodiments, information about the searcher, such as a recruiter, may also be relevant to a prediction from the machine learned models described later. As such, an identification of the searcher may also be communicated via the user interface server component 302 to the ingestion platform 300, which can use the identifications to retrieve the appropriate information corresponding to the searcher from the profile database 218, the social graph database 220, and the member activity and behavior database 222.

The ingestion platform 300 may then provide the relevant information from the profile database 218, the social graph database 220, and the member activity and behavior database 222 to a search result generator 308, which acts to determine which of the potential search results to return and a ranking for those potential search results. In some example embodiments, this information is transmitted in the form of feature vectors. For example, each potential search result may have its own feature vector. In other example embodiments, the ingestion platform 300 sends raw information to the search result generator 308 and the search result generator 308 creates its own feature vectors from the raw information.

The ranked results may then be passed from the search result generator 308 to the user interface server component 302, which acts to cause the user interface client component 304 to display at least a portion of the ranked results.

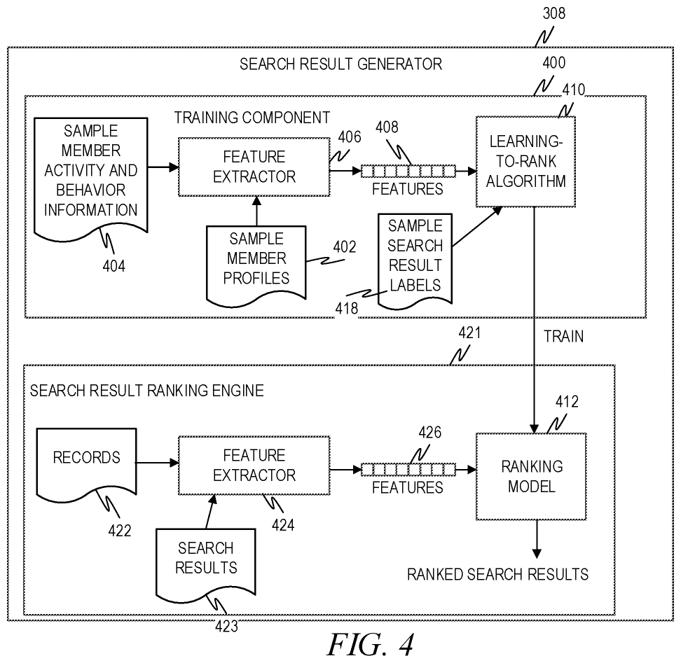

FIG. 4 is a block diagram illustrating the search result generator 308 of FIG. 3 in more detail, in accordance with an example embodiment. In a training component 400, sample member profiles 402 and sample member activity and behavior information 404 are fed to a feature extractor 406, which acts to extract curated features 408 from the sample member profiles 402 and sample member activity and behavior information 404. Different features may be extracted depending upon whether the member profile is assumed to be that of a prospective search result or that of a prospective searcher. Curated features are features that have been placed into a state that is ready to be fed to a machine learning algorithm or machine learned model. What operations are used to curate a feature depends greatly on the feature. Some features are essentially ready to be fed into a machine learned model in the form they are stored in the sample member profiles 402 and/or sample member activity and behavior information 404 and the curation may simply involve copying the feature into a data structure that will be passed to the machine learning algorithm/machine learned model. For example, a feature for location for a user may simply be extracted from a user's profile and placed in the data structure. Other features are, or require, transformations or calculations to be performed on the data from the sample member profiles 402 and/or sample member activity and behavior information 404 prior to being placed in the data structure. For example, a feature for the number of times the user has responded to a communication from a recruiter may require scanning through sample member activity and behavior information 404 looking for times the user received a communication from a recruiter, and counting the number of times the user responded.

In an example embodiment, the curated features 408 are then used to as input to a learning-to-rank algorithm 410 to train a ranking model 412 to generate a combined probability that the searcher will select the corresponding potential search result and that the member associated with the corresponding potential search result will respond to a communication from the searcher.

This training may include providing sample search result labels 418 to the learning-to-rank algorithm 410. Each of these sample search result labels 418 is a relevance measure of how relevant each search result was to the user to which the search result was presented. This may, for example, be a binary measure indicating whether the user interacted with the search result, such as clicked on the search result. Alternatively, a non-binary measure may be used indicating relative levels of relevance. These non-binary measures may be used when multiple different types of interaction are possible, with some indicating more relevance than others. For example, if a recruiter is presented with potential candidate users as search results, clicking on one of the search results indicates some level of interest, saving one of the clicked-on search results indicates a higher level of interest, and sending a communication to the user corresponding to one of the clicked-on search results indicates the highest level of interest. A different score may be used as the label in each of these circumstances.

In a search result ranking engine 421, records 422 are fed to a feature extractor 424. Also fed to the feature extractor 424 are search results 423. The feature extractor 424 acts to extract curated features 426 from the records 422 and search results 423. In some example embodiments, the records 422 include member profile information and member activity and behavior information extracted by the ingestion platform 300, which can use the queries from the user interface server component 302 to retrieve the appropriate information corresponding to potential search results from the profile database 218, the social graph database 220, and the member activity and behavior database 222. The curated features 426 are then used as input to the ranking model 412, which outputs a ranking of the corresponding search results 423.

Turning now to the creation of the feature vectors, as described earlier the feature vectors may be the same or may be different for the different machine learning algorithm inputs. What follows is a non-exhaustive list of various features that could be included in such feature vector(s).

In an example embodiment, the features may be divided into five classes: (1) query features, (2) result features, (3) searcher features, (4) query/result features, and (5) searcher/result features. A query feature is one that is drawn from the query itself, such as in cases where the query identifies a specific attribute of a search result, such as a first name, last name, company, or title.

A result feature is one that is drawn from the search result itself, such as (if the search result is a candidate for a job) industry, whether the candidate is considered an open candidate (a candidate has applied for a job already and is currently under consideration for the job), a job seeker score for the candidate, a number of endorsers of the candidate query/result features, whether the candidate is an influencer, a profile quality score, whether a position or education field is empty, a number of current positions/previous positions, and educations in the search result, a communication delivery score (indicating general willingness to receive communications, as self-reported by members), a quality member score (score calculated by computing how complete a member profile is), a member engagement score, a historical click-through rate for the search result from all recruiters, a historical action rate (e.g., number of all actions taken on the result divided by number of impressions of the result in the last three months), number of communications received, number of communications accepted, a decision maker score, the amount of time since the candidate indicated he or she is an open candidate, and whether the candidate has applied for a job.

A searcher feature is one that is drawn from information about the searcher him or herself, such as industry, historical rate of selection of result, and location.

A query/result feature is one that is drawn from a combination of the query and the search result, such as number of terms in the query that match some text in the search result; number of terms in the query that match specific text fields in the search result; the fraction of terms in the query that match some text in the search result; the fraction of terms in the query that match specific text fields in the search result; the frequency that terms in the query match some text in the search result; the frequency that terms in the query match specific text fields in the search result; if the query contains a first name and a last name and the search result is an influencer, then whether the search result matches the first name and last name; whether a position in the query matches a position in the search result; whether a title in the query matches a title in the search result; Term-Frequency-Inverse Document Frequency score; BM25F score; relative importance of matched terms with respect to the query itself and the fields of the search result (e.g., number of matched terms\hat{ }2/(number of terms in the query*number of terms in the field), generated affinity score created by a product of the query and member embeddings (similarity between search query and search result); raw query and search result matching features for schools; BM25 for current position summary divided by past position summary; clicks by candidate on advertisements from company employing searcher, if the query is a sample job posting; similarity between fields in the job posting and fields in the search result; similarity score between the search result and weighted query terms, with the weights learned online; and deep embedding features for title, skill, company, and field of study.

A searcher/result feature is one that is drawn from a combination of the searcher and the search result, such as network distance (social network degrees of separation between the searcher and the search result), number of common connections, location match, number of matching fields (e.g., current company, past company, school, industry), match score (number of matches squared divided by the product of searcher field size and result field size), recruiter-candidate affinity score (using, e.g., history data for sends and accepts between searcher and search result), number of common groups, and company interest score.

As described briefly earlier, learning-to-rank algorithm 410 may utilize a loss function to perform its training of the ranking model 412. This loss function may be α-divergence.

Let U and D be the query space and the document space, respectively. Let φ: U×D→R^{m} be a feature generation function that maps a query-document pair into a feature vector in R^{m} where m>0 is an integer. For purposes of this disclosure, a document is any piece of content being evaluated as far as potential relevancy to a user. Thus, in the above example, the document is a search result. The document space is the set of all documents under evaluation.

Let U be a set of queries. Each query u ∈ U has a list of feature vectors Xᵤ=(Xᵤ₁, Xᵤₛ, . . . , Xᵤₙ_{ᵤ}), and a list of ground truth labels of relevance levels as Yᵤ=(Yᵤ₁, Yᵤ₂, . . . , Yᵤₙ_{ᵤ}), where the document count for query U, u, Xᵤᵢ ∈ R^{m}, Yᵤᵢ ∈ R for i=1, 2, . . . , nᵤ.

A real-valued ranking function ƒ_{θ}:R^{m}→R parameterized by θ ∈ Θ may be assumed. The ranking function ƒ_{θ} assigns to each document a score by taking corresponding query-document feature vector as its input. Let Sᵤ=(Sᵤ₁, Sᵤ₂, . . , Sᵤₙ_{ᵤ}) where Sᵤᵢ=ƒ_{θ}(Xᵤᵢ) ∈ R for i=1, . . . , nᵤ be the output scores for documents of the query u. Sᵤ=ƒ_{θ}^{e}(Xᵤ) may be used where e signifies the element-wise application of function ƒ_{θ} on Xᵤ.

Finally, a loss function [symbol] e: Rⁿ^{ᵤ}×Rⁿ^{ᵤ}→R quantifies the dissimilarity between the list of document scores and the list of ground truth labels. A document score is the calculated relevancy of a particular piece of content to a particular user. In a typical learning to rank setting, empirical loss is minimized to find the optimal parameters of the ranking function ƒ_{θ}, i.e.,

$$\hat{θ} = {arg min}_{θ ∈ Θ} \frac{1}{\vert U \vert} {\sum }_{uϵU} ℓ ( {f}_{θ}^{e} ( {X}_{u} ) , {Y}_{u} ) .$$

At testing and inference time, the scores Sᵤ=ƒ_{θ}^{e}(Xᵤ) are sorted in descending order to obtain the predicted ranking of documents for query u.

In the above framework, one can choose different ranking functions ƒ_{θ}(·) and loss functions [symbol] (·).

In an example embodiment, α-divergence measures are only defined for positive input measures. Depending on modelling and training data, it is sometimes necessary to first convert scores and ground truth labels into positive measures before divergence can be computed. The converted positive measures do not have to be normalized. In practice, however, the list of documents for a query often has limited length, and thus normalization may be beneficial. In the present document, to simplify notation, it may be assumed that the scores and ground truth labels are first transformed into probability measures before application of a divergence formulation. Transformation of a score or ground truth label to a probability measure means performing conversion and/or normalization of the score or ground truth label into a score falling into the range of 0 and 1, with 0 indicating no probability and 1 indicating 100% probability.

Let ψ:Rⁿ^{ᵤ}→Δⁿ^{ᵤ}⁻¹ be the transformation, and let Δⁿ^{ᵤ}⁻¹≡{x ∈ Rⁿ^{ᵤ}⁻¹|∥x∥₁=1, xᵢ≥0} denote the nᵤ−1 dimensional unit simplex (with nu probability components). Let transformation maps for scores and ground truth labels be ψₛ and ψ_{g}, respectively. Then ψₛ(ƒ_{θ}^{e}(Xᵤ)) and ψ_{g}(Yᵤ) are two probability measures.

For two probability measures P and Q that are absolutely continuous with respect to a probability measure μ, the KL-divergence is

$${D}_{K L} ( P ‖ Q ) = \int p ( x ) log ( \frac{p ( x )}{q ( x )} ) d μ ,$$

and cross-entropy is

D_{CE}(P∥Q)=−∫p(x)log (q(x)dμ.

For α ∈ {0,1}, the α-divergence is defined by

$${D}_{A}^{α} ( P ‖ Q ) = \frac{1}{α ( α - 1 )} ( \int {p}^{α} ( x ) {q}^{1 - α} ( x ) d μ - 1 ) .$$

It is shown that

$${lim}_{α \to 1} {D}_{A}^{α} ( P ‖ Q ) = {D}_{K L} ( P ‖ Q ) , \\ {lim}_{α \to 0} {D}_{A}^{α} ( P ‖ Q ) = {D}_{K L} ( Q ‖ P ) ,$$

and changing α to 1−α swaps the position of P and Q.

For discrete probability measures with mass functions P=[p₁, p₂, . . . , pₜ] and Q=[q₁, q₂, . . . , qₜ] the discrete α-divergence is formulated as:

$${D}_{A}^{α} ( P ‖ Q ) = \frac{1}{α ( α - 1 )} ( {\sum }_{i = 1}^{t} {p}_{i}^{α} {q}_{i}^{1 - α} - 1 ) .$$

As stated above, in an example embodiment, α-divergence is used as the loss function for learning to rank tasks. It can be shown that the constructed loss function can have the property that all its stationary points are its global minimum. Some known properties of the loss function are enumerated as well. By combining the transformations for positive measure and the α-divergence formulation, the following loss function may be defined for learning to rank tasks:

ƒ(Sᵤ, Yᵤ)=D_{A}^{α}(ψₛ(Sᵤ)∥ψ_{g}(Yᵤ)).

With this loss function, one has the freedom of choosing different transformation functions ψₛ and ψ_{g}. One possible choice is the softmax function that converts any vectors of real values into probability measures, i.e., for λ>0,

$${σ}_{λ} ( x ) = {\frac{1}{{Σ}_{i = 1}^{{n}_{u}} exp ( λ {x}_{i} )} [ exp ( λ {x}_{1} ) , . . . , exp ( λ {x}_{{n}_{u}} ) ]}^{T} ,$$

where λ is referred to as the inverse temperature constant. When λ=1, the above formulation becomes the softmax function.

The choice probability ratio between two items is independent of any other items in the set. One can verify that the softmax operation outputs a probability distribution that satisfies the axiom. Entries of the probability distribution from the softmax function can be interpreted as probabilities of corresponding items being the top-1 choice.

Another interpretation is that the softmax function is the maximizing choice map, by using Boltzmann-Gibbs-Shannon (BGS) entropy as the penalty function. By using other generalized entropy functions, such as Tsallis entropy and Berg entropy, as the penalty function for maximization, different transformation functions can be formulated

It is desirable for stationary points of the loss function defined in the equation

ƒ(Sᵤ, Yᵤ)=D_{A}^{α}(ψₛ(Sᵤ)∥ψ_{g}(Yᵤ)).

to be global minimum since gradient descent optimization and its variants can then be safely used to seek the global minimum. The following theorem and its corollary gives a sufficient condition for the loss function to have this property. A theorem is as follows: Let K be a nonempty open convex subset of Rⁿ. Let Rⁿ→R be a differentiable convex function, and g: K→Δⁿ⁻¹ be a map whose Jacobian's left null space is Span(1). Then stationary points of ƒ=h∘g are global minimum over K. A corollary to this is that if the transformation function into probability measures ψₛ has a Jacobian whose left null space is Span(1), then the loss function has the property that all its stationary points in terms of Sᵤ are global minimum.

The following properties of the loss function are directly derived from properties of α-divergence.
1. Stationary points property: When the Jacobian of ψₛ(·) has left null space as Span(1), stationary points of the loss function are always its global minimum. Hence gradient descent and its variant can be safely used to minimize the loss function in terms of ψₛ(·).
2. Nonnegativity: The loss value is always nonnegative, and equal to zero if and only if ψₛ(Sᵤ)=ψ_{g}(Yᵤ).
3. Generalized divergence: When α→1, the loss function becomes KL-divergence-based loss function. When a α→0 the loss function becomes KL-divergence-based loss function with the probability measures swapped. Note cross-entropy loss can be further viewed as a special case of KL-divergence loss provided that:
   1) Probability measure based on ground truth relevance values is passed as the first parameter in KL-divergence and cross-entropy formulations;
   2) Gradient descent or its variants are used in optimization.
4. Convexity: The α-divergence is convex with respect to both ψₛ(Sᵤ) and ψ_{g} (Yᵤ).
5. Boundedness: The α-divergence is bounded.
6. Continuity: The α-divergence is the continuous function of real variable α in the whole range including singularities of {0, 1}.
7. Duality:

D_{A}^{α}(ψₛ(Sᵤ)∥ψ_{g}(Yᵤ))=D_{A}^{1-α}ψ_{g}(Yᵤ)∥ψₛ(Sᵤ)).
8. Inclusive/Exclusive properties:

For α∛+∞, the estimation ψₛ(Sᵤ) that approximates ψ_{g}(Yᵤ) is inclusive, i.e., the mass of ψₛ(Sᵤ) includes all the mass of ψ_{g}(Yᵤ).

For α→+∞, the estimation ψₛ (Sᵤ) that approximates ψ_{g}(Yᵤ) is exclusive, i.e., the mass of ψₛ(Sᵤ) lies within the mass of ψ_{g} (Yᵤ).
9. Zero-forcing and zero-avoiding properties:

Zero-forcing emphasizes approximating the tails, rather than the bulk of the distribution, which tends to miss some modes away from the main mass. Zero-avoiding emphasizes modes and is more inclusive of major distribution mass.

For α≤0, the estimation ψₛ(Sᵤ) that approximates ψ_{g}(Yᵤ) is zero-avoiding, i.e., positive ψ_{g}(Yᵤ) component values force corresponding ψₛ(Sᵤ) components to be positive.

For α≥1, the estimation of ψₛ(Sᵤ) that approximates ψ_{g}(Yᵤ) is zero-forcing (coercive), i.e., zero ψ_{g}(Yᵤ) component values force corresponding ψₛ(Sᵤ) components to be zero.

For 0<α<1, the divergences are a blend of these extremes. They are not zero-forcing, so they try to include multiple modes to a certain degree depending on α value.

As a generalization of the KL-divergence, the α-divergence offers an extra hyperparameter that online networks can take advantage of when training learning-to-rank models. A larger α value makes a model more exclusive, and allows more accurate approximation of irrelevant documents (e.g., higher accuracy in removing spams). A lower a value makes a model more inclusive, and allows more accurate approximation of relevant documents (e.g., higher recall). A balance between the two extremes is usually desirable, although one of the advantages of the solution presented in this disclosure is that the α value may be selected by an administrator/user to best tailor the model to the needs of the specific embodiment where it is being used (i.e., in embodiments where higher accuracy is more important, the administrator may set the a value higher, whereas in embodiments where higher recall is more important, the administrator may set the α value lower.

Note that, when applying the α-divergence formulation, if one swaps the order of ψₛ(Sᵤ) and ψ_{g}(Yᵤ), some properties are swapped accordingly. For example, when swapped α→+∞ would mean the loss function is inclusive (instead of being exclusive).

In an example embodiment, entropy regularization is used in addition to, or in lieu of, the α-divergence.

The entropy regularization ensures that the problem has a unique solution, greater computational stability, and an efficient Sinkhorn algorithm.

KL-divergence is a popular choice as a probability distance measure. It is related to cross-entropy by

D_{KL}(P∥Q)=D_{CE}(P∥Q)−H(P).

When the P is chosen to be the empirical label distribution, the term H(P) is a constant and can be ignored in gradient descent—based optimization strategy (and its variants). Hence usage of cross-entropy divergence with the P representing empirical label distribution is equivalent to usage of the KL-divergence. For this reason, cross-entropy divergence is another popular choice besides KL-divergence in practice.

Note if the Q parameter of the KL-divergence is chosen to be the empirical label distribution, then the term H(P) shall not be ignored as its gradients are nonzero. One can view the term H(P) in KL-divergence as a regularization term subtracted from the remaining cross-entropy divergence measure. In an example embodiment, one goes one step further to suggest using entropy regularization for all divergence measures, including α-divergence in this paper.

The other motivation comes from the principle of maximum entropy. When labels are given in training data, they place restrictions on score distributions among documents at different relevance levels. However, the labels do not dictate score distributions among documents at the same relevance level. Accordingly, entropy regularization to encourage score diversities is a natural choice with the principle.

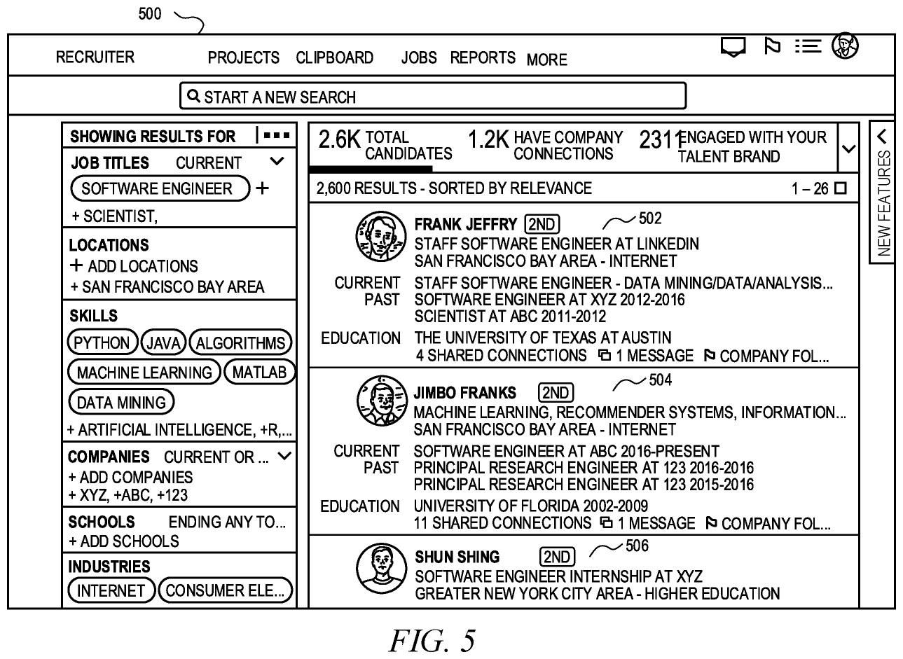

FIG. 5 is a screen capture illustrating a graphical user interface 500 for displaying results of the ranking performed in FIG. 4. Here, one or more candidates 502, 504, 506 are rendered graphically in order of the ranking.

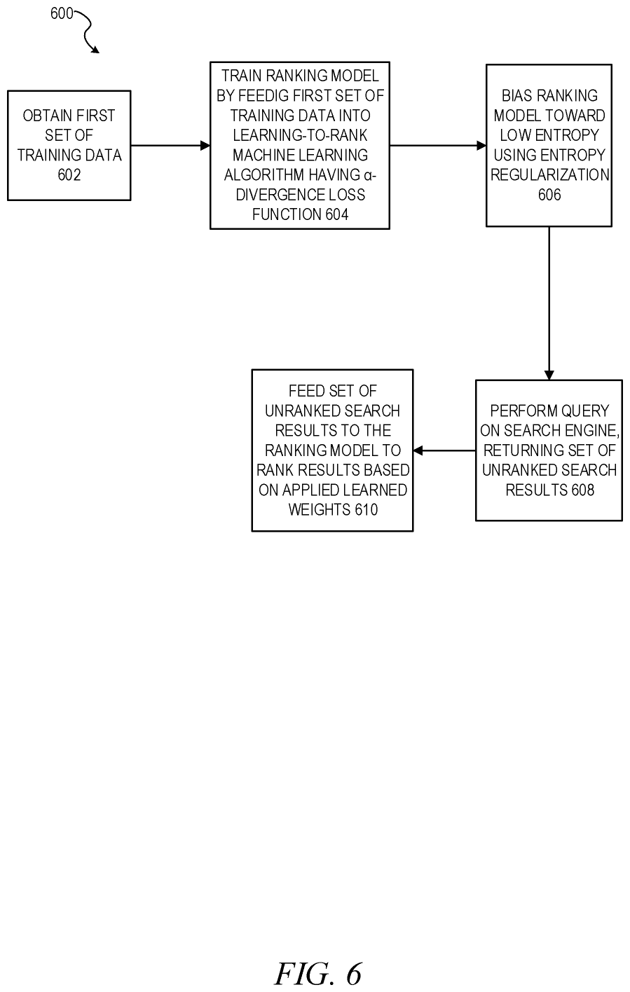

FIG. 6 is a flow diagram illustrating a method 600 of performing machine learning in accordance with an example embodiment. At operation 602, a first set of training data is obtained. The training data comprises a plurality of search results, a plurality of users, and, for each combination of search result and user, a label indicating a relevance of the corresponding search result to the corresponding user. At operation 604, a ranking model is trained by feeding the first set of training data into a learning-to-rank machine learning algorithm, the learning-to-rank machine learning algorithm including a loss function, the loss function being α-divergence. The training learns weights applied to values for input features. The loss function includes a softmax function that converts any vectors of real values into probability measures. The loss function has the property of stationary points being a global minimum of the loss function. The learning-to-rank machine learning algorithm may be a listwise learning-to-rank machine learning algorithm.

At operation 606, the ranking model is biased toward low entropy using entropy regularization. This may include augmenting positive reinforcement in the ranking model with an entropy term, which acts to alter a maximum likelihood solution that the model is optimized on, essentially favoring local maximums rather than a global maximum.

At operation 608, a query is performed on a search engine, returning a set of unranked search results. At operation 610, the set of unranked search results is passed to the ranking model, the ranking model applying the learned weights to input features related to the unranked search results and ranking the unranked search results based on the applied learned weights.

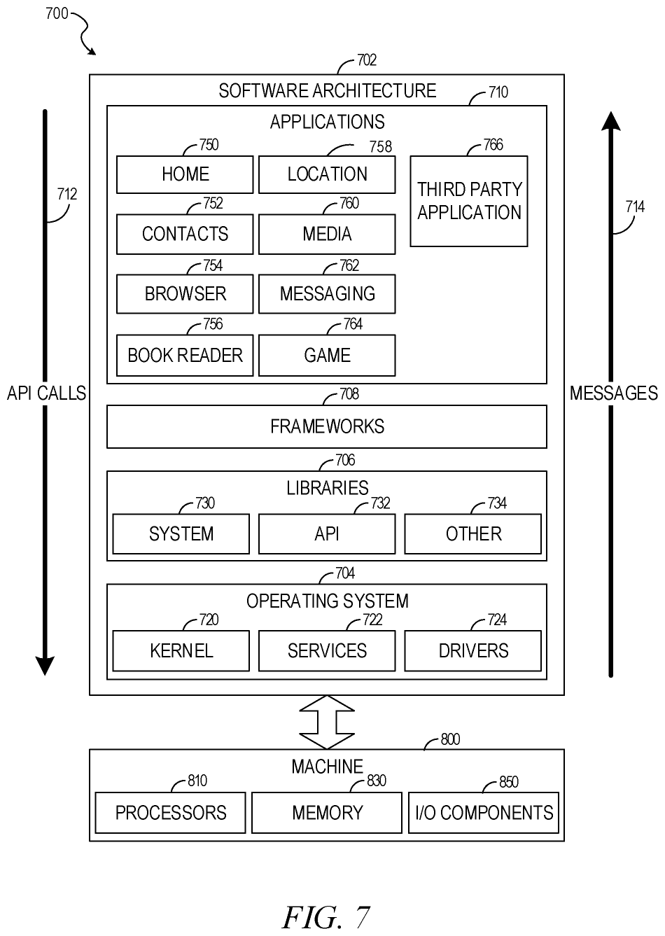

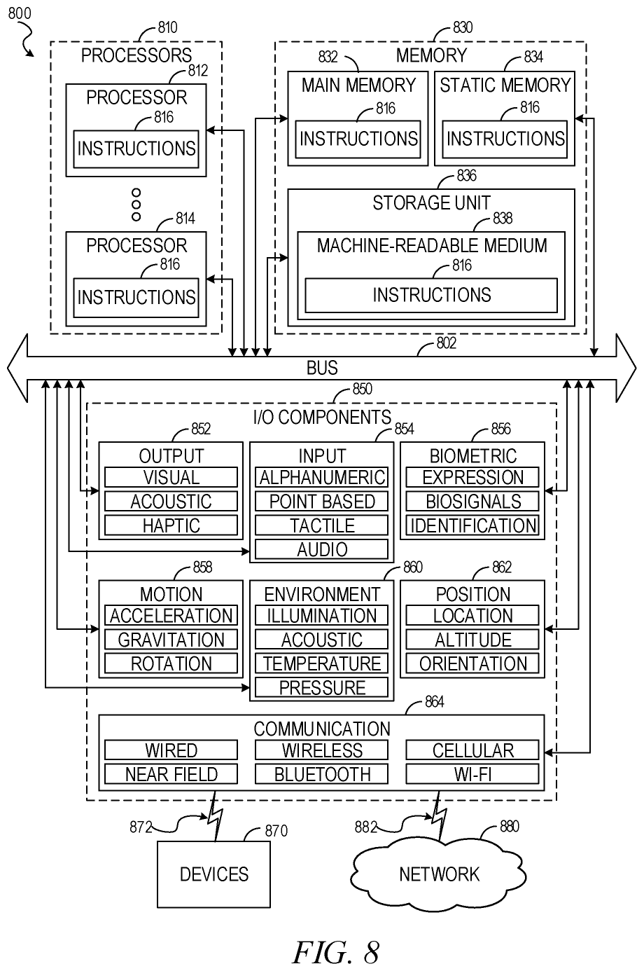

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphic user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application 710, an applet, an app, or other executable code) for causing the machine 800 to perform any one or more of the methodologies discussed herein may be executed. For example, the instructions 816 may cause the machine 800 to execute the method 600 of FIG. 6. Additionally, or alternatively, the instructions 816 may implement FIGS. 1-5, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors 812, 814 (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor), multiple processors 810 with a single core, multiple processors 810 with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine 800 will depend on the type of machine 800. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to the processors 810. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computerized method comprising:
obtaining a first set of training data, the training data comprising a plurality of search results, a plurality of users, and, for each combination of search result and user, a label indicating a relevance of the corresponding search result to the corresponding user;
training a ranking model by feeding the first set of training data into a learning-to-rank machine learning algorithm, the learning-to-rank machine learning algorithm including a loss function, the loss function being α-divergence, the training learning weights applied to values for input features;
performing a query on a search engine, returning a set of search results; and
passing the set of search results to the ranking model, the ranking model applying the learned weights to input features related to the search results and ranking the search results based on the applied learned weights.

2. The method of claim 1, wherein the loss function includes a softmax function that converts any vectors of real values into probability measures.

3. The method of claim 1, wherein the loss function has the property of stationary points being a global minimum of the loss function.

4. The method of claim 1, further comprising biasing the ranking model towards low entropy using entropy regularization.

5. The method of claim 4, wherein the biasing includes augmenting positive reinforcement in the ranking model with an entropy term.

6. The method of claim 1, wherein the learning-to-rank machine learning algorithm is a listwise learning-to-rank machine learning algorithm.

7. The method of claim 1, wherein the ranking model assigns to each input search result, a score by taking a corresponding query-document feature vector as input.

8. The method of claim 1, wherein the query is a query to find one or more user profiles matching query terms in the query, and the input features include features of the query and features of the one or more matching user profiles.

9. The method of claim 1, wherein the input features related to the search results are features calculated based on values contained in the search results.

10. The method of claim 1, wherein the input features related to the search results include features extracted from the search results, features extracted from the query and features extracted from a user profile corresponding to the user.

11. A search result generator, running on a computer system having a hardware processor, comprising:
a training component including:
a feature extractor configured for obtaining a first set of training data, the training data comprising a plurality of search results, a plurality of users, and, for each combination of search result and user, a label indicating a relevance of the corresponding search result to the corresponding user;
a machine-learning algorithm configured for training a ranking model by feeding the first set of training data into a learning-to-rank machine learning algorithm, the learning-to-rank machine learning algorithm including a loss function, the loss function being α-divergence, the training learning weights applied to values for input features;
a search result ranking engine including:
a query performing configured for performing a query on a search engine, returning a set of search results; and
a feature extractor configured for extracting features related to the set of search results and passing the features, with the set of search results, to the ranking model, the ranking model applying the learned weights to the extracted features and ranking the search results based on the applied learned weights.

12. The search result generator of claim 11, wherein the loss function includes a softmax function that converts any vectors of real values into probability measures.

13. The search result generator of claim 11, wherein the loss function has the property of stationary points being a global minimum of the loss function.

14. The search result generator of claim 11, further comprising biasing the ranking model towards low entropy using entropy regularization.

15. The search result generator of claim 14, wherein the biasing includes augmenting positive reinforcement in the ranking model with an entropy term.

16. The search result generator of claim 11, wherein the learning-to-rank machine learning algorithm is a listwise learning-to-rank machine learning algorithm.

17. The search result generator of claim 11, wherein the ranking model assigns to each input search result, a score by taking a corresponding query-document feature vector as input.

18. The search result generator of claim 11, wherein the query is a query to find one or more user profiles matching query terms in the query, and the input features include features of the query and features of the one or more matching user profiles.

19. The search result generator of claim 11, wherein the input features related to the search results are features calculated based on values contained in the search results.

20. The search result generator of claim 11, wherein the input features related to the search results include features extracted from the search results, features extracted from the query and features extracted from a user profile corresponding to the user.
